(19) United States
(12) Patent Application Publication
(10) Pub. No.: US 2010/0184304 A1
(43) Pub. Date: Jul. 22, 2010

(54) Retractable Protection Mechanism For Electrical Connection Pins

(76) Inventor: David R. Ekstrom, Oregon City, OR (US)

Correspondence Address: RAYMOND J. WERNER, 2056 NW ALOCLEK DRIVE, SUITE 314, HILLSBORO, OR, 97124, US

(21) Appl. No.: 12/684,867

(22) Filed: Jan. 8, 2010

Related U.S. Application Data
(60) Provisional application No. 61/143,355, filed on Jan. 8, 2009.

(51) Int. Cl. H01R 13/44; H01R 24/06; H01R 13/64

(52) U.S. Cl. 439/41; 439/136; 29/741

(57) ABSTRACT

Retractable protection apparatus, and methods for use, provide protection for vertically oriented electrical connection pins from unintended bending, while further providing operability that allows protected pins to be uncovered to at least the extent necessary to make electrical connection with one or more connectors, and covered after coupling with the connectors is no longer required. In a further aspect, a locking mechanism is provided to prevent the retractable protection mechanism from retracting during shipping or similar handling. In a still further aspect, the retractable protection apparatus is segmented so that only selected portions of the vertically oriented electrical connection pins may be exposed for electrical access.

### CROSS-REFERENCE TO RELATED APPLICATIONS

This non-provisional application claims the benefit of provisional application No. 61/143,355, filed 8 Jan. 2009, and entitled “Retractable Protection Mechanism For Electrical Connection Pins”, the entirety of which is hereby incorporated by reference.

### FIELD OF THE INVENTION

The present invention relates generally to mechanical apparatus for the protection of electrical connection pins, and more particularly relates to a retractable protection mechanism for electrical connection pins that is operable to allow physical access to the protected electrical connection pins.

### BACKGROUND

Many electrical and electronic systems have a requirement to electrically communicate signals and/or power between two or more individual units, such as, for example, printed circuit boards. A wide variety of connectors and connection schemes have been developed over the years to accomplish such electrical communication.

One particular means of providing electrical connections includes one or more substantially vertically oriented pins disposed on the surface of a substrate. Such pins may then be fitted into, or mated with, a connector, or socket, to provide electrical connection therebetween.

Unfortunately, arrangements which include a plurality of vertically oriented, electrically conductive pins are often subject to damage from handling. That is, one or more of the vertically oriented pins may bend such that those pins no longer properly engage with the connector or socket to which they are intended to connect.

What is needed are methods and apparatus for preventing electrical connection pins from bending into undesired shapes and/or orientations.

### SUMMARY OF THE INVENTION

Briefly, retractable protection apparatus and methods for use provide protection for vertically oriented electrical connection pins from unintended bending, while further providing operability that allows protected pins to be uncovered to at least the extent necessary to make electrical connection with one or more connectors, and covered after coupling with the connectors is no longer required.

In a further aspect, a locking mechanism is provided to prevent the retractable protection mechanism from retracting during shipping or similar handling.

### BRIEF DESCRIPTION OF THE DRAWINGS

FIG. 1 is a cross-sectional illustration of a wafer translator having wafer contact structures on the wafer-side thereof, and vertical pins suitable for use with a Zero Insertion Force (ZIF) socket on the inquiry-side.

FIG. 2 is a cross-sectional view of a retractable protection mechanism including a guard plate, in the extended position, disposed on the inquiry-side of a wafer translator.

FIG. 3 is a cross-sectional view of a retractable protection mechanism, in the extended position, disposed on the inquiry-side of a wafer translator without a guard plate.

FIG. 4 is a cross-sectional view of the retractable protection mechanism of FIG. 4, in the extended position, with a “fuzz-button” style electrical contact mechanism disposed within the sockets.

FIG. 5 is a cross-sectional view of the retractable protection mechanism of FIG. 4 in the retracted position.

FIG. 6 is a cross-sectional view of the retractable protection mechanism with an O-ring shown disposed between an recess in a ZIF socket and a corresponding recess in a guard plate of the retractable protection mechanism to form an evacuation pathway between and external vacuum source and the compressible material disposed subjacent the guard plate.

FIG. 7 is a flow diagram of a process for protecting and accessing electrical connection pins with a retractable protection mechanism in accordance with the present invention.

### DETAILED DESCRIPTION

Generally, for an array of electrical pins, such as, for example, those associated with Pin Grid Array (PGA) packages, a retractable protection mechanism in accordance with the present invention may include a plate that is thinner than the length of those pins, has openings therein that match the patterns of the pin locations, and is backed by an open cell foam or similar material having coaxially aligned openings therein. Generally the plate and backing material are electrically non-conductive, and have a total height equal to, or in excess of, the length of the pins. In this way, the tips of the pins are flush with, or recessed from, the plate. Thus the pins are protected from being intercepted or bent by undesired contacts, i.e., applications of force. When the pins are to be inserted into a Zero Insertion Force (ZIF) socket, which clamps the pins from their sides, as opposed to pressing the pins into a traditional socket wherein pressure is applied along the axis of the pins, the plate can be independently pushed, thus compressing the foam and allowing the pins to be exposed and therefore accessible to the ZIF socket. Alternatively, an insertion process may, after aligning the ZIF socket and retractable protection mechanism to each other, urge the ZIF socket and plate together resulting in compression of the foam behind the plate, and thereby exposing the pins and allowing access to the pins for insertion in the socket. In some embodiments, a lock preventing the compression of the foam, and the consequent exposure of the pins, is provided to maintain protection during shipment or other handling.

Reference herein to “one embodiment”, “an embodiment”, or similar formulations, means that a particular feature, structure, operation, or characteristic described in connection with the embodiment, is included in at least one embodiment of the present invention. Thus, the appearances of such phrases or formulations herein are not necessarily all referring to the same embodiment. Furthermore, various particular features, structures, operations, or characteristics may be combined in any suitable manner in one or more embodiments.

### Terminology

Pad refers to a metallized region of the surface of an integrated circuit, which is used to form a physical connection terminal for communicating signals and/or power to and/or from the integrated circuit. Pads are sometimes referred to as terminals, I/O pads, contact pads, bond pads, bonding pads, chip pads, test pads, or similar formulations. It will be appreciated that “I/O pads” is a general term, and that the present invention is not limited with regard to whether a particular pad of an integrated circuit is part of an input, output, or input/output circuit.

The expression “wafer translator” refers to an apparatus that facilitates the electrical coupling of the pads disposed on unsingulated integrated circuits, to other electrical components. A wafer translator is typically disposed between a wafer and other electrical components, and/or electrical connection pathways. The wafer translator is typically removably attached to the wafer (alternatively the wafer is removably attached to the translator, or the wafer and wafer translator are removably attached to each other). A wafer/wafer translator pair in the attached state may be a portable assembly. The wafer translator includes a substrate having a first major surface and a second major surface, each of the first and second major surfaces having terminals disposed thereon, and electrical pathways disposed through the substrate to provide for electrical continuity between at least one terminal on a first surface and at least one terminal on a second surface. The wafer-side of the wafer translator has a pattern of terminals that matches the layout of at least a portion of the pads of the integrated circuits on the wafer. The wafer translator, when disposed between a wafer and other electrical components such as an inquiry system interface, makes electrical contact with one or more pads of a plurality of integrated circuits on the wafer, providing an electrical pathway therethrough to the other electrical components. The wafer translator is a structure that is used to achieve electrical connection between one or more electrical terminals that have been fabricated at a first scale, or dimension, and a corresponding set of electrical terminals that have been fabricated at a second scale, or dimension. The wafer translator provides an electrical bridge between the smallest features in one technology (e.g., pins of a probe card) and the largest features in another technology (e.g., bonding pads of an integrated circuit). For convenience, wafer translator is referred to simply as translator where there is no ambiguity as to its intended meaning. In some embodiments a flexible wafer translator offers compliance to the surface of a wafer mounted on a rigid support, while in other embodiments, a wafer offers compliance to a rigid wafer translator. The surface of the translator that is configured to face the wafer in operation is referred to as the wafer-side of the translator. The surface of the translator that is configured to face away from the wafer is referred to as the inquiry-side of the translator. An alternative expression for inquiry-side is tester-side.

The terms chip, integrated circuit, semiconductor device, and microelectronic device are sometimes used interchangeably in this field. The present invention relates to the manufacture and test of chips, integrated circuits, semiconductor devices and microelectronic devices as these terms are commonly understood in the field.

As used herein, the terms vertical and vertically oriented, refer to an orientation that is substantially perpendicular to the plane of a substrate, such as but not limited to printed circuit boards and wafer translators.

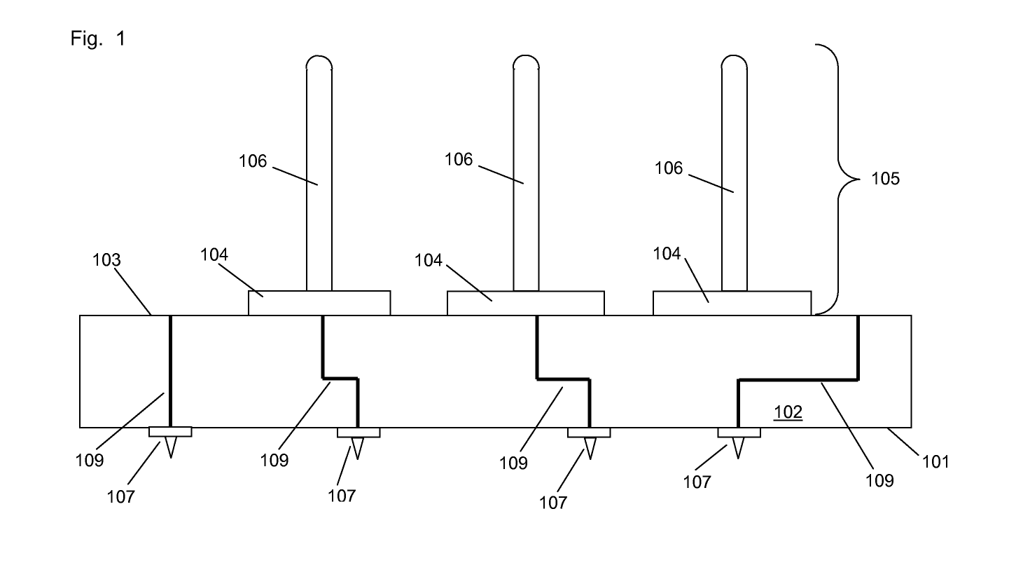

In a structure having a large number of electrical connection pins, accidental damage to one or more of the pins compromises the utility of the structure. Such structures include, but are not limited to, wafer translators having vertically oriented pins disposed on the inquiry-side thereof. Such wafer translators may have, for example, from 5,000 to 500,000 pins. FIG. 1 is a cross-section of a wafer translator substrate 102 having electrical contact structures 105 disposed on an inquiry-side 103 thereof, these illustrative electrical contact structures include a base portion 104 and an upwardly extending pin portion 106. Base portion 104 and pin portion 106 may be formed of any suitable materials and may be attached by any suitable means. In typical embodiments, base portion 104 and pin portion 106 are electrically conductive. In some embodiments, pin 106 is gold-plated bronze. As shown in FIG. 1, a plurality of contact structures 107 are disposed on wafer-side 101 of wafer translator substrate 102. Electrically conductive pathways 109 are disposed in wafer translator substrate 102 to provide electrical pathways between wafer-side contact structures 107 and corresponding inquiry-side contact structures 105.

In accordance with the present invention, retractable protection apparatus, and methods for use, provide protection for vertically oriented electrical contact structures including pins substantially vertically oriented with respect to a substrate from which they are extending, from unintended bending, while further providing operability that allows protected pins to be uncovered to at least the extent necessary to make electrical connection with one or more connectors, and covered after coupling with the connectors is no longer required. Integral retractable protection for large arrays of pins has utility for a wide variety of electrical and electronic products.

In one exemplary embodiment of the present invention, the retractable protection mechanism includes a layer of a first compressible material having a first set of openings therethrough, and a layer of a second material disposed on the layer of first material, the second material having a first set of openings therethrough such that the first set of openings in the first material and the first set of openings in the second material are coaxially aligned. The first compressible material and the second material are disposed on a substrate having one or more pins vertically disposed thereon, such that the first openings of the first and second materials are coaxially aligned with the one or more pins, and the pins fit through the aforementioned openings. The combined height of the first material and the second material is preferably substantially equal to the height of the one or more pins. The second material further has a second set of openings through which air, or other gases, may be withdrawn so as to allow atmospheric pressure to compress, or reduce the height of, the first layer of compressible material, thereby exposing the vertically oriented pins. The exposed pins may then be coupled to a socket, such as, for example, a Zero Insertion Force (ZIF) socket. In some embodiments, the ZIF socket has a set of openings that are coaxially aligned with the second set of openings in the second material. The aligned second openings of the second material and the ZIF socket provide a pathway for removing and returning air, or other gases, to the compressible first material. In some embodiments a gasket or similar structure is disposed between the second material and the ZIF socket to prevent leakage into or out of the pathway formed by the placement of the ZIF socket on the second material. It is noted that a similarly configured Low Insertion Force (LIF) socket may alternatively be used.

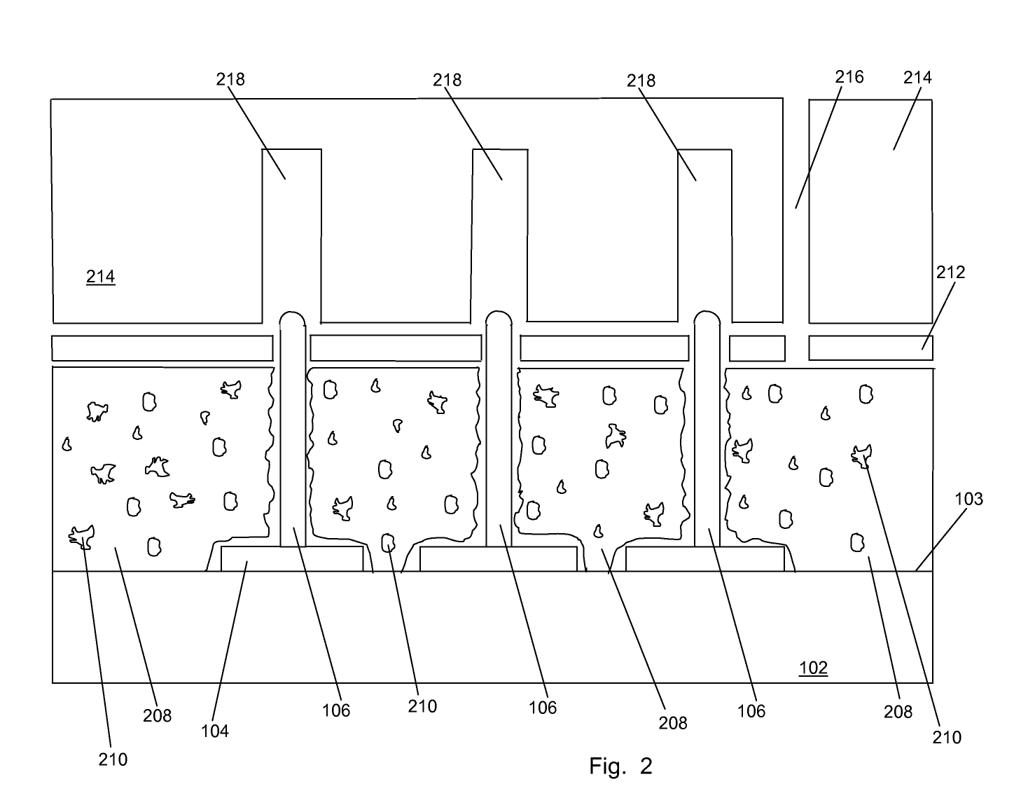

Referring to the cross-sectional illustration of FIG. 2, a substrate 102 has a plurality of electrical contact structures disposed on a first major surface thereof. In this illustrative embodiment, substrate 102 is a wafer translator substrate and the first major surface is the inquiry-side 103 of the wafer translator. In this illustrative embodiment, each electrical contact structure includes a base portion 104, and a pin portion 106. A retractable protection structure in accordance with the present invention includes a first compressible layer of material 208, and a second layer of material 212. First compressible layer 208 and second layer 212 each have a respective first set of openings therethrough. For clarity of illustration, first layer 208 and second layer 212 are shown with a gap therebetween, however, in actual embodiments of the present invention, second layer 212, also referred to as a guard plate, is disposed on first layer 208. More particularly, second layer 212 is disposed on first layer 208 such that the respective first sets of openings are coaxially aligned with each other. First compressible layer 208 is typically comprised of a foam that has a network of spaces, or cavities, or openings, 210 therein. The spaces within the foam are typically contain atmospheric gases. Second layer 212 is typically a material that is “air-tight”, or substantially impervious to the movement of air, or other gases, therethrough. First layer 208 and second layer 212, with their coaxially aligned respective first sets of openings, are disposed over substrate 102 such that each one of pins 106 pass at least part way through the coaxially aligned openings.

It is noted that the present invention contemplates embodiments in which the combined height of first layer 208 and second layer 212 (i.e., the distance from the surface of substrate 102 on which the retractable protection mechanism is disposed to the surface of second layer 212 that is farthest from the aforementioned surface of substrate 102) is greater than or less than the height of pin 106 (i.e., the distance from the surface of substrate 102 on which the retractable protection mechanism is disposed to the top of pin 106).

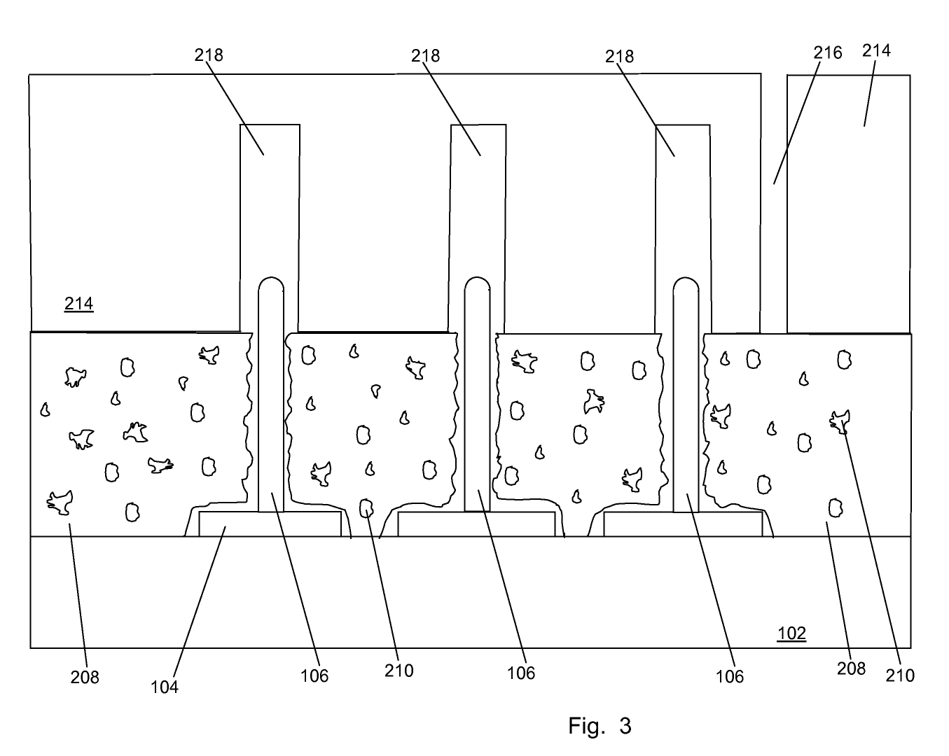

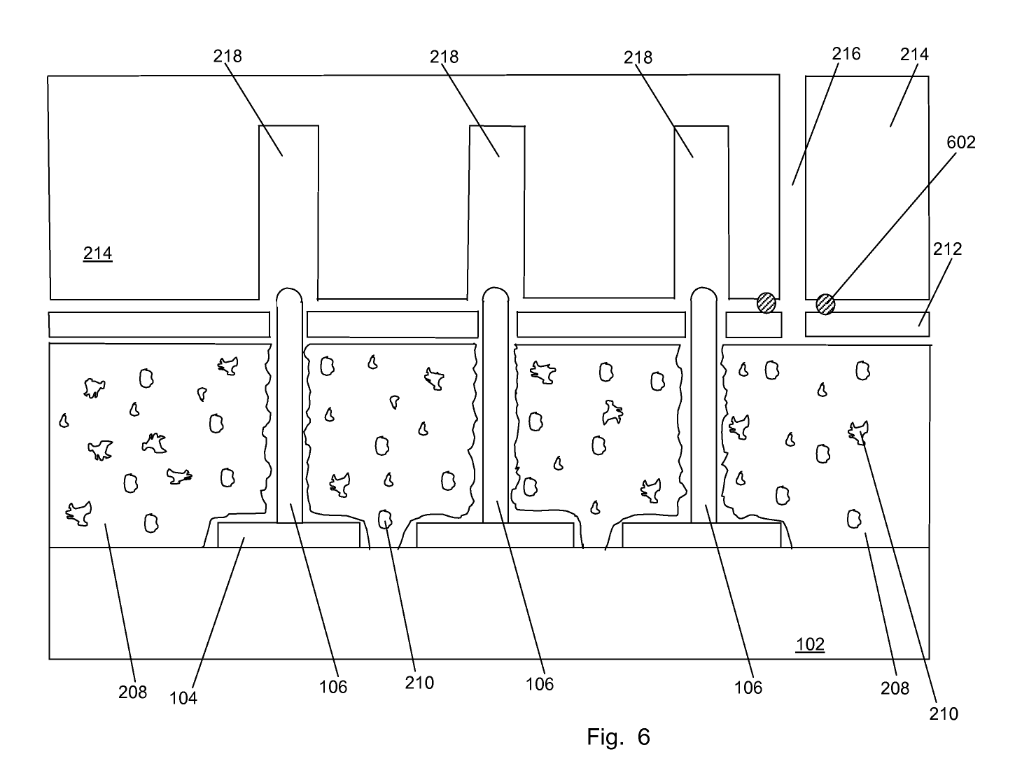

Still referring to FIG. 2, a simplified cross-sectional representation of a ZIF socket 214 is shown superjacent guard plate 212 of an illustrative retractable protection mechanism in accordance with the present invention. In this arrangement the individual pin receptacles 218 of ZIF socket 214 are aligned with respective first sets of openings in guard plate 212 and compressible layer 208, and are correspondingly aligned to pins 106 of the inquiry-side contact structures of wafer translator substrate 102. ZIF socket 214 further includes an opening 216 therethrough. It is noted that when receptacles 218 of ZIF socket 214 are aligned with pins 106, ZIF socket opening 216 is also aligned with a corresponding second opening in guard plate 212. ZIF socket opening 216 and the corresponding second opening in guard plate 212 form a pathway through which gas(es) may be evacuated from, or re-introduced into, compressible layer 208. In some embodiments, ZIF socket 214 is disposed directly on guard plate 212 and this physical contact forms a sufficiently sealed connection that compressible layer 208 may be successfully evacuated and/or inflated. In some embodiments, a gasket, such as but not limited to an O-ring, is disposed between the ZIF socket and guard plate to assist in the formation of the evacuation pathway (see O-ring 602 in FIG. 6). In still other embodiments (see FIG. 3), the guard plate is eliminated and ZIF socket 214 is disposed directly upon compressible layer 208.

In some embodiments, compressible layer 208 is attached to inquiry-side 103 by means of an adhesive disposed between at least one or more portions of inquiry-side 103, and the surface of compressible layer 208 that faces inquiry-side 103. Similarly, in some embodiments, guard plate 212 is attached to compressible layer 208 by means of an adhesive disposed between at least one or more portions of the facing surfaces of compressible layer 208 and guard plate.

Referring to FIG. 3, an arrangement similar to that of FIG. 2 is shown, except that in this illustrative embodiment, guard plate 212 has been eliminated and ZIF socket 214 is disposed directly upon compressible layer 208. In this arrangement, opening 216 in ZIF socket 214 forms a pathway through which air is removed at rate sufficient to overcome any leakage pathways in compressible layer 208 thereby allowing compression of layer 208, exposure of pins 106, and capture of pins 106 in receptacles 218 of ZIF socket 214. It is noted that even though only one opening 216 is shown in ZIF socket 214 for removal of air, the present invention contemplates embodiments with a plurality of such openings.

It is further noted that opening 216 may be connected to a vacuum source in any suitable manner. It is still further noted that in the context of the present invention, a vacuum source need only produce a pressure lower than the atmospheric pressure in which the retractable protection mechanism is being used.

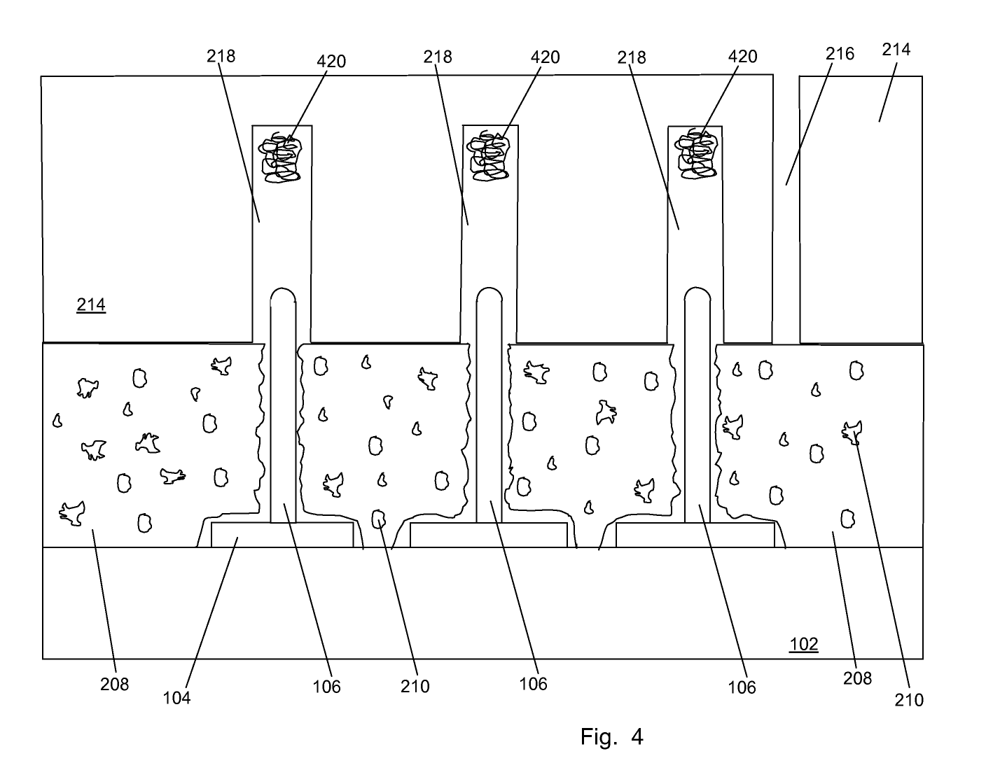

Referring to FIG. 4, a cross-sectional view of the retractable protection mechanism of FIG. 3, in the partially retracted position, with a “fuzz-button” style electrical contact mechanism 420 disposed within receptacles 218 is shown.

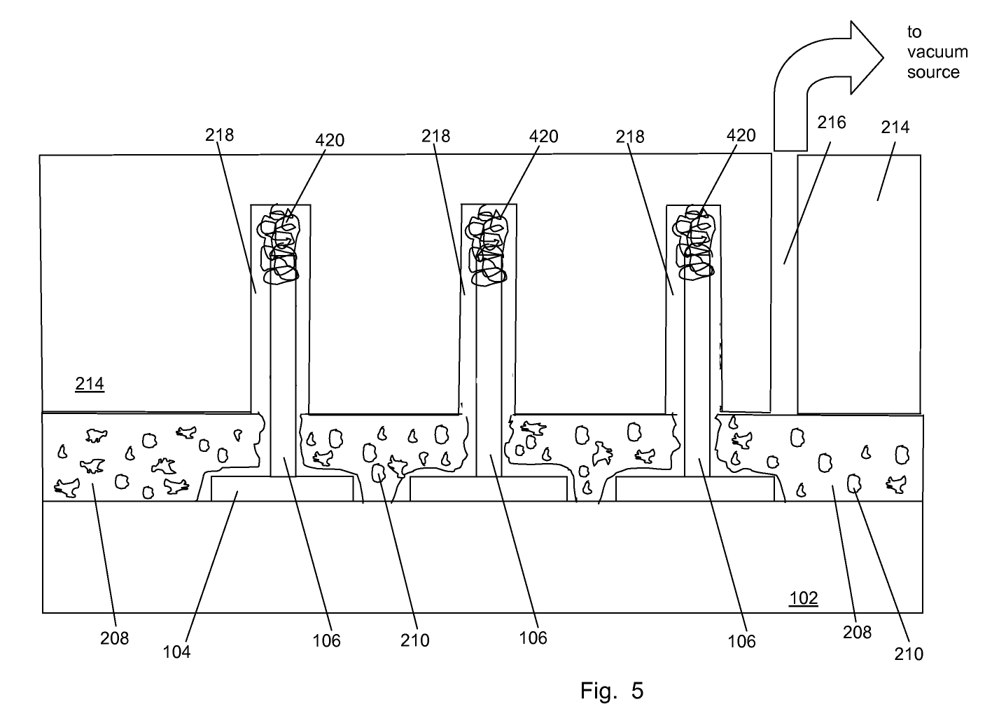

FIG. 5 is a cross-sectional view of the retractable protection mechanism of FIG. 4 in the retracted position (i.e., air has been evacuated from compressible material 208 which has consequently been compressed by atmospheric pressure), wherein pins 106 have engaged with fuzz-button style electrical contact mechanism 420.

As mentioned above, FIG. 6 is a cross-sectional view of the retractable protection mechanism with an O-ring shown disposed between opening 216 in ZIF socket 214 and a corresponding opening in guard plate 212 of the retractable protection mechanism to form an evacuation pathway between an external vacuum source and compressible layer 208 disposed subjacent guard plate 212. It is noted that a recess may be provided in guard plate 212, in ZIF socket 214, or in both, for seating O-ring 602.

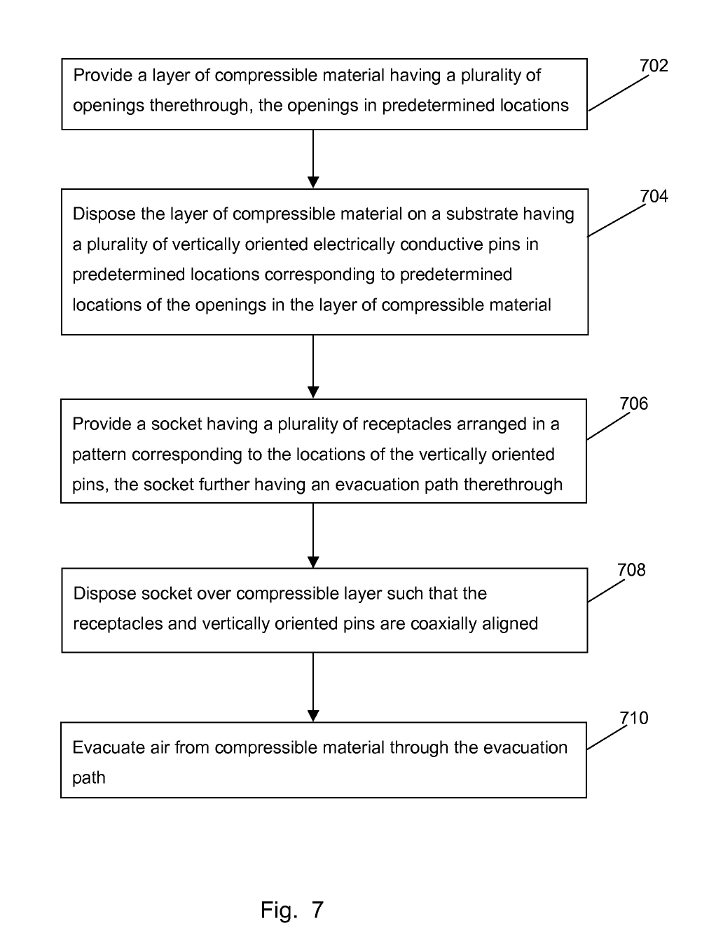

Referring to FIG. 7, a process of protecting and accessing vertically oriented electrical connection pins is shown. The process of FIG. 7 includes providing 702 a layer of compressible material having a plurality of openings therethrough, the openings in predetermined locations; disposing 704 the layer of compressible material on a substrate having a plurality of vertically oriented electrically conductive pins in predetermined locations corresponding to predetermined locations of the openings in the layer of compressible material; providing 706 a socket having a plurality of receptacles arranged in a pattern corresponding to the locations of at least a portion of the vertically oriented pins, the socket further having at least one evacuation path therethrough; disposing 708 the socket over at least a portion of the compressible layer such that the receptacles and vertically oriented pins are coaxially aligned; and evacuating 710 air from at least a portion of the compressible material through the at least one evacuation path.

In another exemplary embodiment of the present invention, the retractable protection mechanism includes a layer of a first inflatable material having a first set of openings therein, and a layer of a second material disposed on the layer of first material, the second material having a first set of openings therein such that the first set of openings in the first material and the first set of openings in the second material are coaxially aligned. The second material further has a second set of openings through which air, or other gases, may be introduced so as to inflate, or increase the height of, the first layer of material, thereby covering the vertically oriented pins.

In some embodiments where it is desirable to access only a portion of the vertically oriented electrical connection pins, the retractable protection mechanism is segmented, or partitioned, such that those segments may be individually evacuated, thereby exposing only the desired portion of the vertically oriented electrical connection pins. It is noted that these segments may be evacuated one at a time, evacuated in selected groups of segments less than all the segments, or evacuated all together. The size of a particular ZIF socket may be different depending on how many or how few of the segments are to be evacuated at the same time.

In one illustrative structural embodiment of the present invention, a vacuum activated retractable protection mechanism for electrical connection pins includes a layer of open cell foam having a first major surface and a second major surface, the layer of open cell foam further having a first set of openings therethrough; a guard plate having a first major surface and a second major surface and further having a first set of openings and a second set of openings therethrough, the second major surface of the guard plate disposed on the first major surface of the layer of open cell foam such that the first set of openings of the guard plate are coaxially aligned with the first set of openings of the layer of open cell foam. Typically, the first set of openings of the guard plate and of the layer of open cell foam are sized so that the aforementioned electrical connection pins may fit through those openings. In typical embodiments the patterns of the first sets of openings of the layer of open cell foam and of the guard plate are arranged to match the pattern of vertically oriented electrical connection pins on a substrate. Typically, the combination of the open cell foam and the guard plate has a height that is substantially equal to or greater than the height of the electrical connection pins. In one embodiment, the pattern of vertically oriented electrical connection pins is disposed on the inquiry-side of a wafer translator, but the invention is not limited to use with wafer translators.

In a further aspect of the illustrative embodiment, a ZIF fixture having a first major surface and a second major surface, and further having a set of openings therethrough, the second major surface of the ZIF fixture disposed on the first major surface of the guard plate such that the set of openings of the ZIF socket are coaxially aligned with the second set of openings of the guard plate. The pathway created by the coaxially aligned second set of guard plate openings and the ZIF fixture openings forms an evacuation pathway such that the air, or other gas(es) may be evacuated from the layer of open cell foam. The remainder of the ZIF fixture may be conventional, and as such is adapted to grip the electrical connection pins after they are exposed above the surface of the guard plate as a result air being removed from the layer of open cell foam and the consequent compression of that layer due to atmospheric pressure.

In another illustrative embodiment of the present invention, a method includes providing a substrate having substantially vertically oriented electrical connection pins disposed on a first surface thereof; disposing a retractable protection mechanism over the substrate such that the electrical connection pins are fitted through openings in the retractable protection mechanism. In this illustrative method the retractable protection mechanism includes a layer of open cell foam having a first major surface and a second major surface, the layer of open cell foam further having a first set of openings therethrough; a guard plate having a first major surface and a second major surface and further having a first set of openings and a second set of openings therethrough, the second major surface of the guard plate disposed on the first major surface of the layer of open cell foam such that the first set of openings of the guard plate are coaxially aligned with the first set of openings of the layer of open cell foam. In this embodiment the default condition of the retractable protection mechanism is an extended state such that the combination of foam and guard plate has a height substantially equal to or greater than the height of the electrical connection pins.

In some embodiments, the layer of open cell foam is a self-skinning open cell foam, whereas in other embodiments, the layer of open cell foam is not self-skinning.

In some embodiments the default condition of the retractable protection mechanism is retracted, and must be inflated to return to the extended position for protection of the vertically oriented electrical connection pins.

### CONCLUSION

It is to be understood that the present invention is not limited to the embodiments described above, but encompasses any and all embodiments within the scope of the subjoined Claims and their equivalents.

What is claimed is:

1. A retractable pin protection apparatus, comprising:
a layer of inflatable material having a first set of openings therein;
a layer of a second material disposed on the layer of first material, the second material having a first set of openings therein that are arranged such that the first set of openings in the layer of inflatable material, and the first set of openings in the layer of second material are coaxially aligned; and
wherein the layer of second material has a second set of openings through which one or more gases are introduced to the layer of inflatable material.

2. The retractable pin protection apparatus of claim 1, the retractable pin protection apparatus is disposed over a substrate having a plurality of vertically oriented electrical pins thereon such that the electrical pins pass at least partially through the coaxially aligned openings.

3. The retractable pin protection apparatus of claim 2, wherein the one or more gases include air.

4. The retractable pin protection apparatus of claim 2, wherein the second set of openings in the layer of the second material provides a pathway for evacuating the one or more gases from the layer of inflatable material.

5. A vacuum-activated retractable protection mechanism for electrical pins that are substantially vertically oriented with respect to a substrate on which the electrical pins are disposed, comprising:
a layer of open cell foam having a first major surface and a second major surface, the layer of open cell foam further having a first set of openings therethrough; and
a guard plate having a first major surface and a second major surface and further having a first set of openings and a second set of openings therethrough, the second major surface of the guard plate disposed on the first major surface of the layer of open cell foam such that the first set of openings of the guard plate are coaxially aligned with the first set of openings of the layer of open cell foam;
wherein the first set of openings of the guard plate and the first set openings of the layer of open cell foam are sized so that the electrical pins may fit through those openings.

6. The vacuum-activated retractable protection mechanism of claim 5, wherein the first set of openings of the guard plate and the first set openings of the layer of open cell foam are each arranged in a pattern that matches the pattern of the vertically oriented electrical pins.

7. The vacuum-activated retractable protection mechanism of claim 5, wherein the open cell foam and the guard plate, taken together, have a height that is substantially equal to or greater than the height of the electrical connection pins.

8. The vacuum-activated retractable protection mechanism of claim 7, wherein the substrate is a printed circuit board.

9. The vacuum-activated retractable protection mechanism of claim 7, wherein the substrate is a wafer translator.

10. The vacuum-activated retractable protection mechanism of claim 7, wherein the retractable protection mechanism is segmented such that it has a plurality of segments which may be individually evacuated.

11. A method of protecting and accessing vertically oriented electrical connection pins, comprising:
providing a layer of compressible material having a plurality of openings therethrough, the openings in predetermined locations;
disposing the layer of compressible material on a substrate having a plurality of vertically oriented electrically conductive pins in predetermined locations corresponding to predetermined locations of the openings in the layer of compressible material;
providing a socket having a plurality of receptacles arranged in a pattern corresponding to the locations of the vertically oriented pins, the socket further having an evacuation path therethrough;
disposing the socket over at least a portion of the layer of compressible material such that the receptacles and at least a portion of the vertically oriented pins are coaxially aligned; and
evacuating air from the layer of compressible material through the evacuation path.

12. The method of claim 11, wherein the layer of compressible material is an open cell foam.

13. The method of claim 11, wherein the substrate is a printed circuit board.

14. The method of claim 11, wherein the substrate is an integrated circuit package.

15. The method of claim 11, wherein the substrate is a wafer translator.

16. The method of claim 11, wherein the socket is a ZIF socket.

17. The method of claim 11, wherein the layer of compressible material is segmented.

18. The method of claim 11, further comprising:
disposing a guard plate on the layer of compressible material prior to disposing the socket over at least a portion of the layer of compressible material;
wherein the guard plate has a first set of openings therethrough and a second set of openings therethrough, the first set of guard plate openings coaxially aligned with a least a portion of the plurality of openings in the compressible material.
